(19) United States
(12) Patent Application Publication
(10) Pub. No.: US 2024/0230861 A1
(43) Pub. Date: Jul. 11, 2024

(54) CLOSE RANGE INTERFERENCE REDUCTION

(71) Applicant: Luminar Technologies, Inc., Orlando, FL (US)

(72) Inventors: Kevin A. GOMEZ, Eden Prairie, MN (US); Adam R. BUSH, Plymouth, MN (US)

(21) Appl. No.: 18/405,078

(22) Filed: Jan. 5, 2024

Related U.S. Application Data
(60) Provisional application No. 63/437,234, filed on Jan. 5, 2023.

(51) Int. Cl. G01S 7/495; G01S 7/48; G01S 7/4861; G01S 7/487; G01S 7/497

(52) U.S. Cl. CPC G01S 7/495; G01S 7/4861; G01S 7/4873; G01S 7/497; G01S 7/4808

(57) ABSTRACT

The disclosure herein describes reduction of undesired signals within reflected signals of a light detection and ranging (LiDAR) system. For example, a current injection circuit can inject an interference reduction current into an optical detector. Further, for example, an adjustable detection threshold may be adjusted during an undesired signal time period. Still further, for example, a switch can be used to disconnect various detection circuitry to avoid or mask undesired signals.

### CROSS-REFERENCE TO RELATED APPLICATIONS

This application is a non-provisional application based on and takes priority from pending U.S. provisional application Ser. No. 63/437,234, entitled “Close Range Interference Reduction,” which was filed on Jan. 5, 2023. The disclosure set forth in the referenced application is incorporated herein by reference in its entirety.

### BACKGROUND

The present disclosure relates to light detection and ranging (LiDAR), and in particular, reduction of close-range interference in the detection apparatus.

### SUMMARY

One illustrative apparatus may include an amplifier to receive a reflected signal representative of a light signal received by an optical detector in a light detection and ranging (LiDAR) system and a current injection circuit operably coupled to the optical detector and configured to inject an interference reduction current into the optical detector to reduce undesired signals within the reflected signal.

One illustrative method for light detection and ranging (LiDAR) may include providing a reflected signal representative of a light signal received by an optical detector in a LiDAR system to an amplifier and injecting an interference reduction current into the optical detector using a current injection circuit to reduce undesired signals within the reflected signal.

One illustrative apparatus may include an amplifier to receive a reflected signal representative of a light signal received by an optical detector in a light detection and ranging (LiDAR) system and an active threshold adjustment circuit operably coupled to the amplifier. The active threshold adjustment circuit may be configured to provide an adjustable detection threshold used to detect an object of interest and increase the adjustable detection threshold to reduce undesired signals within the reflected signal.

One illustrative method for light detection and ranging (LiDAR) may include providing a reflected signal representative of a light signal received by an optical detector in a LiDAR system to an amplifier, providing, using an active threshold adjustment circuit operably coupled to the amplifier, an adjustable detection threshold used to detect an object of interest, and increasing the adjustable detection threshold to reduce undesired signals within the reflected signal.

One illustrative apparatus may include an amplifier to receive a reflected signal representative of a light signal received by an optical detector in a light detection and ranging (LiDAR) system, a comparator operably coupled to the amplifier to receive an output of the amplifier and to generates an edge signal indicative of an object of interest in response to the received output, and a switch operably positioned between the output of the amplifier and the comparator to operably disconnect the output of the amplifier from the comparator when undesired signals are expected to be received by the comparator from the amplifier.

One illustrative method for light detection and ranging (LiDAR) may include providing a reflected signal representative of a light signal received by an optical detector in a LiDAR system to an amplifier, generating an edge signal indicative of an object of interest, using a comparator, in response to received output, wherein the comparator is operably coupled to the amplifier to receive an output of the amplifier, and operably disconnecting the output of the amplifier from the comparator when undesired signals are expected to be received by the comparator from the amplifier.

The above summary is not intended to describe each embodiment or every implementation of the present disclosure. A more complete understanding will become apparent and appreciated by referring to the following detailed description and claims taken in conjunction with the accompanying drawings. In other words, these and various other features and advantages will be apparent from a reading of the following detailed description.

### BRIEF DESCRIPTION OF THE DRAWINGS

The disclosure may be more completely understood in consideration of the following detailed description of various embodiments of the disclosure in connection with the accompanying drawings.

FIG. 1 depicts an illustrative LiDAR system interacting with a target and operably coupled to an external system.

FIG. 2 depicts an illustrative emitter of the LiDAR system of FIG. 1.

FIGS. 3A-3B depict different output systems utilizable by the LiDAR system of FIG. 1.

FIG. 4 depicts an illustrative detector of the LiDAR system of FIG. 1.

FIG. 5 depicts an illustrative general detection circuit of the LiDAR system of FIG. 1.

FIG. 6 depicts an illustrative detection circuit of the LiDAR system of FIG. 1 that utilizes a current injection circuit to reduce undesired signals within the reflected signal.

FIG. 7 depicts another illustrative detection circuit of the LiDAR system of FIG. 1 that utilizes another current injection circuit different than FIG. 6. to reduce undesired signals within the reflected signal.

FIG. 8A depicts an illustrative detection circuit of the LiDAR system of FIG. 1 that utilizes an active threshold adjustment circuit to reduce undesired signals within the reflected signal.

FIG. 8B depicts another illustrative detection circuit of the LiDAR system of FIG. 1 that utilizes an active threshold adjustment circuit to reduce undesired signals within the reflected signal.

FIG. 9 depicts another illustrative detection circuit of the LiDAR system of FIG. 1 that utilizes another active threshold adjustment circuit different than FIG. 8. to reduce undesired signals within the reflected signal.

FIG. 10 depicts another illustrative detection circuit of the LiDAR system of FIG. 1 that utilizes a switch to reduce undesired signals within the reflected signal.

FIG. 11 depicts an illustrative function of Vₜ over time.

### DETAILED DESCRIPTION

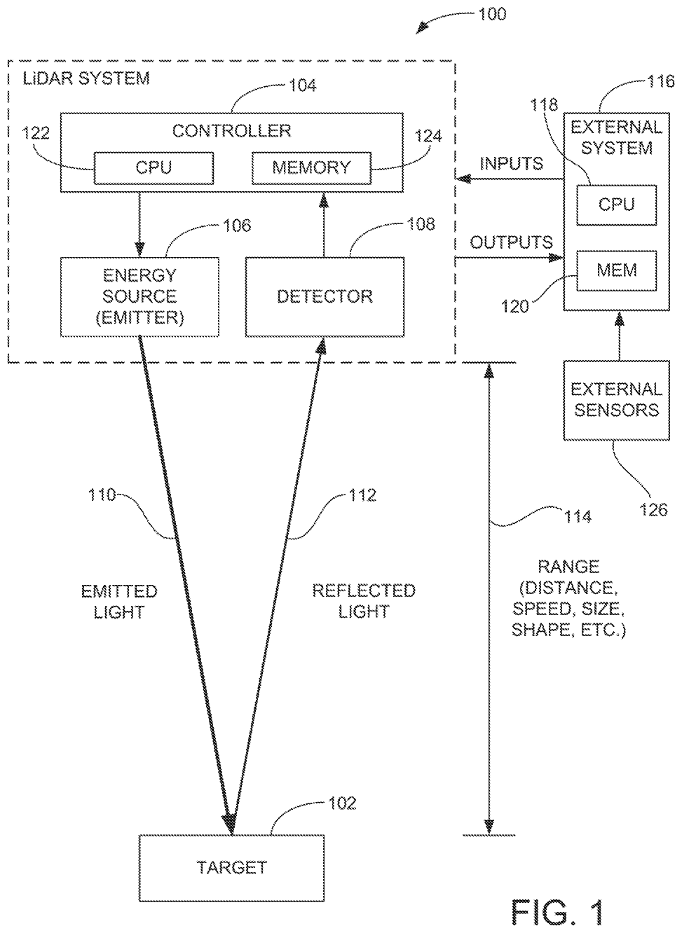

Illustrative devices, systems, apparatus, methods, and processes shall be described with reference to FIGS. 1-11. It will be apparent to one skilled in the art that elements or processes from one embodiment may be used in combination with elements or processes of the other embodiments, and that the possible embodiments of such devices, systems, apparatus, methods, and processes using combinations of features set forth herein is not limited to the specific embodiments shown in the figures and/or described herein. Further, it will be recognized that the size and shape of various elements herein may be modified but still fall within the scope of the present disclosure, although certain one or more shapes and/or sizes, or types of elements, may be advantageous over others.

Co-located optical transmit and receive paths, like those used in some light detection and ranging (LiDAR) mechanical scanning configurations, may place stringent requirements on the quality of anti-reflection coatings (ARC) of optical mirrors, transmission glass, lenses, etc. Even when perfect ARC application has occurred, there is often enough light scattered of the optical interface to return to the sense element resulting in an unwanted return signal. This unwanted return signal can cause a masking effect in the detector that effectively “blinds” the detector from a real signal that may return just beyond the optical boundary of the unit. Thus, various apparatus including optical mirrors, transmission glass, lenses, etc. of a LiDAR system may result in close-range interference that provides unwanted, or undesired, signals to the processing circuitry of the LiDAR system used to determine distance to objects of interest from wanted, or desired, reflected signals.

Various embodiments of the present disclosure are generally directed to reducing close range interference. In particular, for example, the illustrative devices, systems, apparatus, methods, and processes may be designed or configured to effectively mask un-wanted or undesired light and/or cancel un-wanted or undesired signals in the electrical channel to overcome close range interference.

As will be described in further detail herein, the illustrative devices, systems, apparatus, methods, and processes may inject a current into a cathode (e.g., high side) of a sense element (e.g., photodiode) to cancel current of undesired, or unwanted, signals from a received signal, e.g., resulting from close range interference. In one embodiment, an alternating current (AC) coupled voltage waveforms may be utilized to effectively accomplish cancel current from the un-wanted signal. Exact cancellation of the un-wanted signal may not be provided when injecting a current into the cathode of the sense element but may be advantageous to over-cancel the received signal because of the excess signal available in the received signal from nearby targets.

Further, as will be described in further detail herein, the illustrative devices, systems, apparatus, methods, and processes may be configured to reject un-wanted signals using active channel threshold adjustment, e.g., using either stepped threshold adjustments or tuned ramps that follow a LiDAR range equation (e.g., 1/r 2) or another advantageous ramp (e.g., log or polynomial). In one embodiment, the active channel threshold adjustment can be utilized at the final comparator where the channel threshold is set. In another embodiment, the active channel threshold adjustment can be utilized at a transimpedance amplifier (TIA) reference input based on the channel threshold.

Still further, as will be described in further detail herein, the illustrative devices, systems, apparatus, methods, and processes may be the input of the comparator may be masked with a switch. The switch can effectively disable the comparator measurement output and/or prevent the analog channel measurement from reaching the comparator.

Light detection and ranging (LiDAR) systems are useful in a number of applications in which range information (e.g., distances, etc.) from an emitter to a target are detected by irradiating the target with electromagnetic radiation in the form of light. The range information is detected in relation to timing and/or waveform characteristics of reflected light received back by the system. LiDAR applications include autonomously piloted or driver assisted vehicle guidance systems, topographical mapping, surveying, and so on. LiDAR systems are particularly useful in generating a three-dimensional (3D) point cloud representation of the surrounding environment in the applicable field of view (FoV). While not limiting, the light wavelengths used in a typical LiDAR system may range from ultraviolet to near infrared (e.g., 250 nanometers (nm) to 1500 nm or more) with native light frequencies in the terahertz (THz, 10¹² Hz) range. Moreover, other wavelength and frequency ranges can be used.

These and other features and advantages of various embodiments can be understood beginning with a review of FIG. 1, which provides a simplified functional representation of a LiDAR system 100 constructed and operated in accordance with various embodiments of the present disclosure. The LiDAR system 100 is configured to obtain range information regarding a target 102 that is located distal from the system 100. The information can be beneficial for a number of areas and applications including, but not limited to, topography, archeology, geology, surveying, geography, forestry, seismology, atmospheric physics, laser guidance, automated driving and guidance systems, closed-loop control systems, etc.

The LiDAR system 100 includes a controller 104 which provides top level control of the system. The controller 104 can take any number of desired configurations, including hardware and/or software. In some cases, the controller can include the use of one or more programmable processors with associated programming (e.g., software, firmware, etc.) stored in a local memory which provides instructions that are executed by the programmable processor(s) during operation. Other forms of controllers can be used, including hardware-based controllers, digital signal processors (DSPs), field programmable gate arrays (FPGAs), system on chip (SOC) integrated circuits, application specific integrated circuits (ASICs), gate logic, reduced instruction set computers (RISCs), etc.

An energy source circuit 106, also sometimes referred to as an emitter or a transmitter, operates to direct electromagnetic radiation in the form of light pulses toward the target 102. A detector circuit 108, also sometimes referred to as a receiver or a sensor, senses reflected light pulses received back from the target 102. The controller 104 directs operation of the emitted light from the emitter 106, denoted by arrow 110, and decodes information from the reflected light obtained back from the target, as denoted by arrow 112. The reflected light 112, upon reception by the detector, may be converted into a received signal. As described herein, the received signal may include interference or other un-desired signals therein caused by, e.g., scattered light and/or reflection caused by physical components such as the lens and ARC thereof in the detector.

Double-sided arrow 114 depicts the actual, true range information associated with the intervening distance (or other range parameter) between the LiDAR system 100 and the target 102. Depending on the configuration of the system 100, the range information can include the relative or absolute speed, velocity, acceleration, distance, size, location, reflectivity, color, surface features and/or other characteristics of the target 102 with respect to the system 100.

The decoded range information can be used to perform any number of useful operations, such as controlling a motion, input, or response of an autonomous vehicle, generating a topographical map, recording data into a data structure for further analysis and/or operations, etc. The controller 104 may be configured to perform these operations directly, or can communicate the range information to an external system 116 for further processing and/or use.

In some cases, inputs supplied by the external system 116 can activate and configure the system to capture particular range information, which is then returned to the external system 116 by the controller 104. The external system 116 can take any number of suitable forms, and may include a system controller (such as central processing unit (CPU) 118), local memory 120, etc. The external system may define or form a portion of a closed-loop control system and the range information output by the LiDAR system 100 can be used by the external system 116 to adjust the position of a moveable element.

The controller 104 of the LiDAR system 100 can incorporate one or more programmable processors (e.g., CPUs) 122 that execute program instructions in the form of software/firmware stored in a local memory 124, and which communicate with the external controller 118. External sensors 126 can provide further inputs used by the external system 116 and/or the LiDAR system 100.

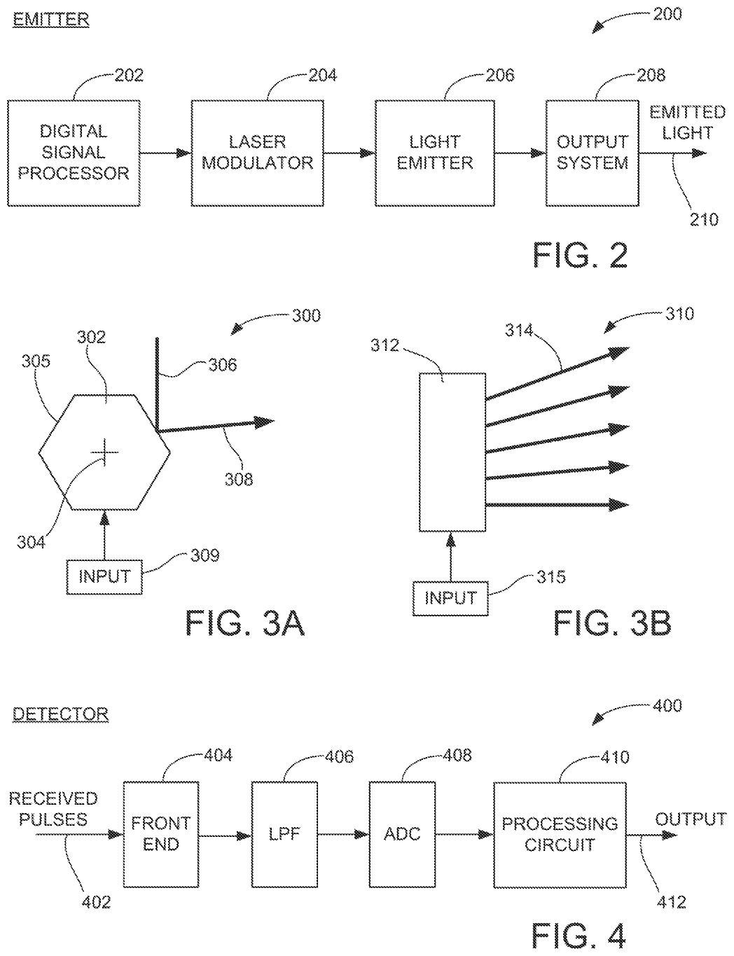

FIG. 2 depicts an emitter circuit 200 that can be incorporated into the system 100 of FIG. 1 in some embodiments. Other arrangements can be used so the configuration of FIG. 2 is merely illustrative and is not limiting. The emitter circuit 200 includes a digital signal processor (DSP) 202 that provides adjusted inputs to a laser modulator 204, which in turn adjusts a light emitter (e.g., a laser, a laser diode, etc.) that emits electromagnetic radiation (e.g., light) in a desired spectrum. The emitted light is processed by an output system 208 to issue a beam of emitted light 210. The light may be in the form of pulses, coherent light, non-coherent light, swept light, etc.

FIGS. 3A-3B show different aspects of some forms of output systems that can be used by the system of FIG. 2. It is to be understood that other arrangements can be used. For example, FIG. 3A shows a system 300 that includes a rotatable polygon 302 which is mechanically rotated about a central axis 304 at a desired rotational rate. The polygon 302 may include or define reflective outer surfaces 305 adapted to direct incident light 306, e.g., received from the light emitter 206, as a reflected stream 308 at a selected angle responsive to the rotational orientation of the polygon 302. The polygon 302 may be characterized as a hexagon with six reflective sides, but it is to be understood that any number of different configurations can be used. By coordinating the impingement of light 306 and rotational angle of the polygon 302, the output light 308 can be swept across a desired field of view (FoV). An input system 309, such as a closed loop servo system, can control the rotation of the polygon 302.

FIG. 3B provides a system 310 including and utilizing a solid-state array (e.g., integrated circuit device) 312 configured to emit light beams 314 at various selected angles across a desired FoV. Unlike the mechanical system of FIG. 3A, the solid-state system of FIG. 3B has essentially no moving parts. As before, a closed loop input system 315 can be used to control the scan rate, density, etc. of the output light 314. Other arrangements can be used as desired, including digital light processing technology (e.g., micromirror), etc.

Regardless of the configuration of the output system, FIG. 4 provides a generalized representation of a detector 400 configured to process reflected light issued by the system of FIG. 2. The detector 400 receives reflected pulses 402 that are processed by a suitable front end 404. The front end 404 can include optics, detector grids, amplifiers, mixers, and other suitable features to present input pulses reflected from the target. As described herein, one or more portions of LiDAR systems such as one or more portion of the front end 404 may introduce interference or other un-desired signals by providing scattered light and/or reflection caused. It is to be understood that the particular configuration of the front end 404 is not germane to the present disclosure, and so further details have not been included. It will be appreciated that multiple input detection channels can be utilized.

A low pass filter (LPF) 406 and an analog to digital converter (ADC) 408 can be used as desired to provide some processing of the input pulses. A processing circuit 410 provides suitable signal processing operations to generate a useful output 412.

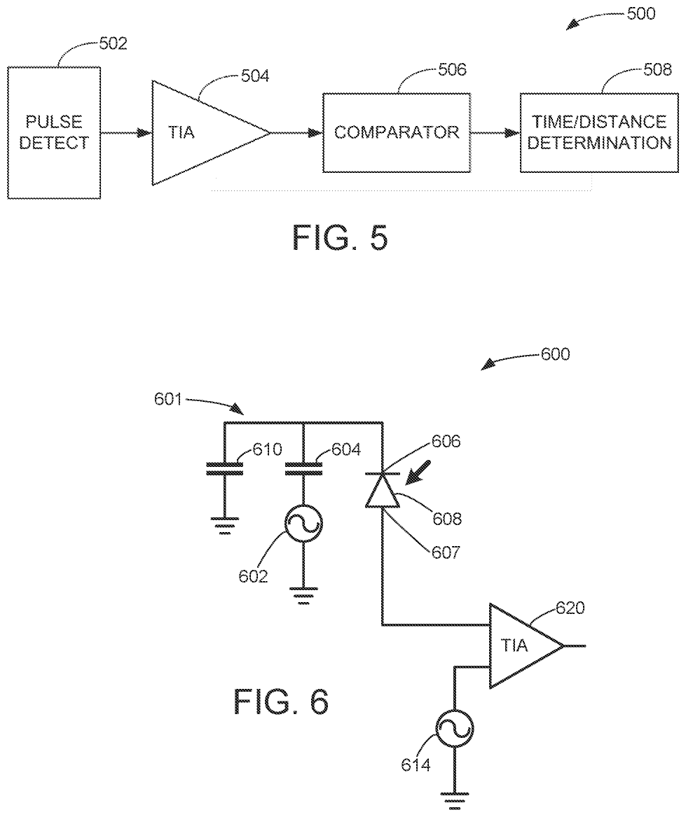

FIG. 5 shows a detection circuit 500 constructed and operated in accordance with further embodiments. The detection circuit 500 can be incorporated into the various systems described above including the LiDAR system 100 of FIG. 1 and the detector 400 of FIG. 4. It will be appreciated that the circuit 500 is merely illustrative and is not limiting, as other circuit arrangements can be used in accordance with the principles set forth in the present disclosure.

The detection circuit may include a pulse detect stage 502 to receive reflected pulses from the target 102. The pulse detect stage 502 can include optics, photodiodes (e.g., low-noise avalanche photodiode (APDs)), and other front-end processing elements. The output of the pulse detect stage 502 is supplied to a transimpedance amplifier (TIA) 504 configured to convert the input current pulse to a voltage pulse of selected magnitude. The TIA 504 may further act as an electronic filter, such a low-pass filter that removes or attenuates high-frequency electrical noise by attenuating signals above a particular frequency.

The TIA 504 may be provided with its own internal adjustable gain stage or a separate downstream gain stage (not shown) to generate an output that is processed by a downstream comparator circuit 506. The comparator circuit 506 produces an electrical-edge signal (e.g., a rising edge or a falling edge) when the received voltage signal rises above or falls below an adjustable detection threshold Vₜ.

A time/distance determination circuit 508 may receive the edge detection signals from the comparator 506 and may determine range information therefrom, including an interval of time between emission of a pulse of light by the light source of the emitter and receipt of the edge signal from the comparator 506, referred to as the time of flight (ToF). The output of the circuit 508 may be a numerical value that corresponds to the TOF, and may be a relatively short value such as in the nanosecond to picosecond range (e.g., 10-9 to 10-12 seconds) A high-speed internal clock may be used to digitize the ToF to some selected gradient. The ToF flight information is used to generate an accurate determination of the actual distance between the emitter and the target. Longer distance targets will tend to provide lower power reflected signals while shorter distance targets will provide higher power reflected signals.

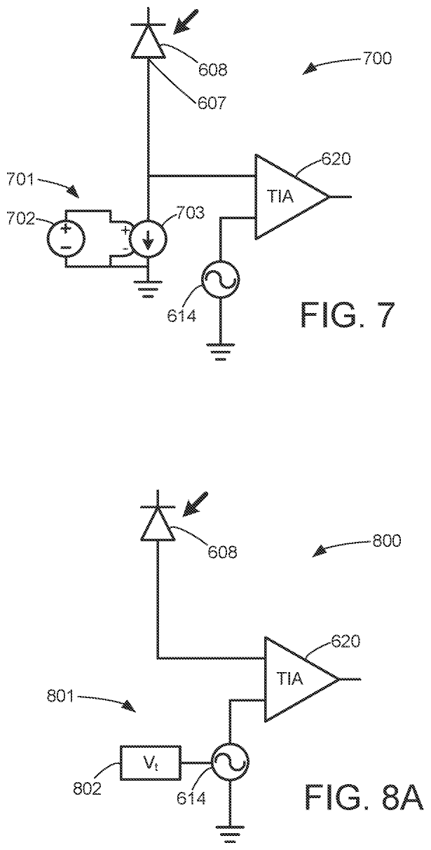

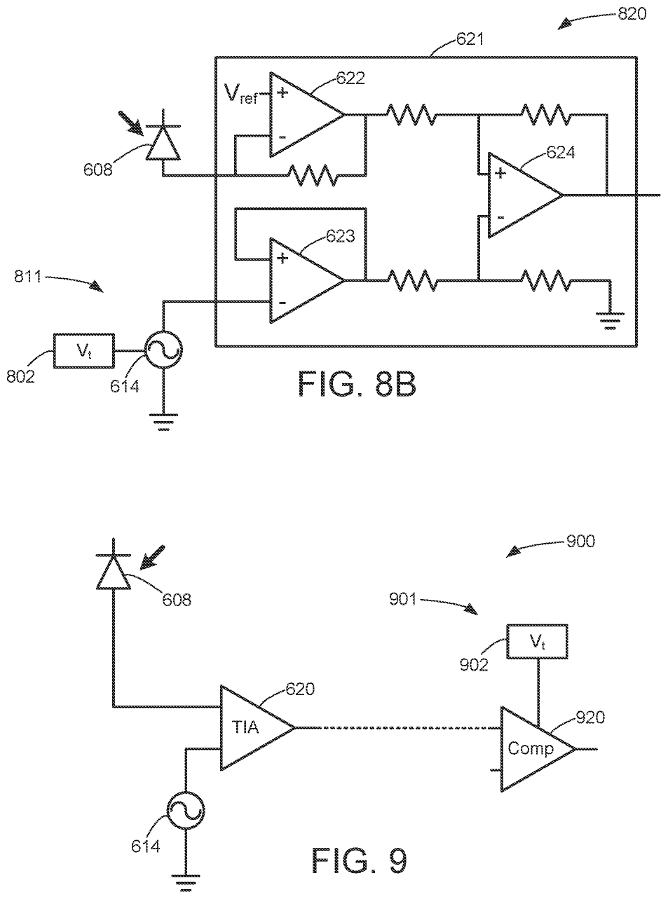

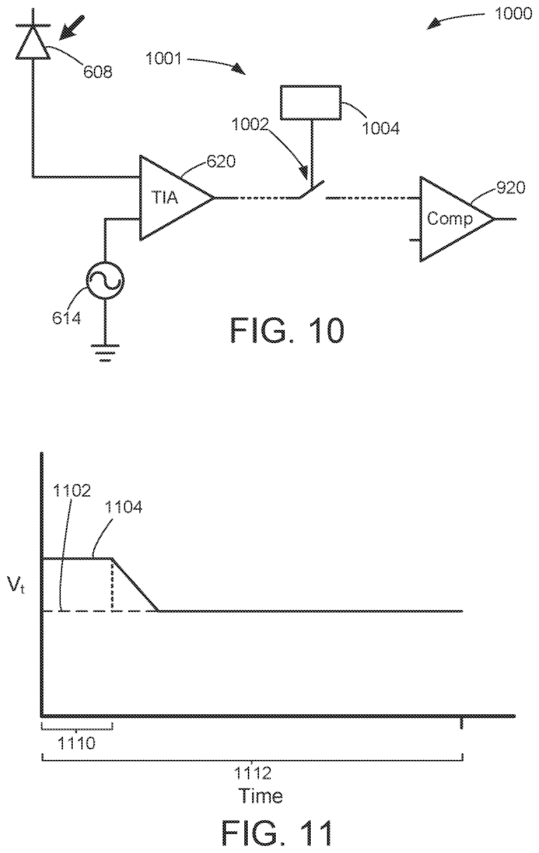

The pulse detection circuit 502, TIA 504, and the comparator 506 may be configured to reduce undesired signals within the reflected signal. For example, the pulse detection circuit 502, TIA 504, and the comparator 506 may include a current injection circuit that injects an interference reduction current into an optical detector, e.g., the photodiode, to reduce undesired signals within the received, reflected signal as illustrated in FIGS. 6-7. Further, for example, the pulse detection circuit 502, TIA 504, and the comparator 506 may include an active threshold adjustment circuit to provide an adjustable detection threshold transmitted to a reference input of the TIA as shown in FIGS. 8A-8B or the comparator as shown in FIG. 9 to reduce undesired signals within the reflected signal. Still further, for example, a switch may be operably positioned between the output of the TIA 504 and the comparator 506 to operably disconnect the output of the TIA 504 from the comparator 506 when undesired signals are expected to be received by the comparator from the amplifier as shown in FIG. 10.

An illustrative detector circuit 600 of the LiDAR system 100 of FIG. 1 that utilizes a current injection circuit 601 to reduce undesired signals within the reflected signal is depicted in FIG. 6. As shown, the current injection circuit 601 includes an AC voltage waveform source 602 and a capacitor 604 defining an AC coupled voltage waveform to inject, or provide, an interference reduction current to a cathode 606, or high side, of the APD 608. The capacitor 604 may be configured to reduce a DC component from the interference reduction current. Additionally, the current injection circuit 601 further includes an additional capacitor 610 in parallel with the capacitor 604. The capacitor 610 may be described as a primary bias decoupling capacitor that provides primary APD 608 decoupling. Further, as shown, the anode 607 of the APD 608 is operably coupled to the input of the TIA 620 to provide the reflected signal received by the APD 608 and adjusted by the interference reduction current provided by the current injection circuit 601 to the TIA 620. Also, the detector circuit 600 further includes a reference source 614 operably coupled to the reference input of the TIA 620.

The amperage of the interference reduction current may be selected to bias the APD 608 to ignore or filter unwanted signals within the range of about 1 microampere to about 10 microamperes. To do so, the interference reduction current may be selected to match or exceed the unwanted signal current, for example, between about 1 microampere and about 10 microamperes. In at least one embodiment, the interference reduction current is 1 microampere. The interference reduction current may be fixed or adjustable by changing the voltage of the AC voltage waveform source 602. More specifically, for example, the interference reduction current is adjustable by the magnitude of voltage of the AC voltage waveform source 602 and the ratio of the circuit parasitics as well as the normal capacitor equation I=C*dV/dt. In other words, the interference reduction current can be fixed at a calibrated level during factory testing or may be adjusted based on feedback from the time of flight (ToF) and ADC inputs. Additionally, in one or more embodiments, each individual pixel could have a different interference reduction current.

Another illustrative detection circuit 700 of the LiDAR system of FIG. 1 that utilizes another current injection circuit 701 different than FIG. 6 to reduce undesired signals within the reflected signal is depicted in FIG. 7. As shown, the current injection circuit 701 is operably coupled to the anode 607 of the APD 608 and the input of the TIA 620 to inject the interference reduction current into the anode 607 of the APD 608 to, e.g., in effect, pull current from the anode 607. In this embodiment, the current injection circuit 701 includes a voltage source 702 operably coupled to a transconductance element 703 such as, e.g., a transistor (e.g., an NMOS or NPN device).

Detection circuits 800, 820, 900 of the LiDAR system of FIG. 1 that utilize active threshold adjustment circuits 801, 811, 901 to reduce undesired signals within the reflected signal are depicted in FIGS. 8-9. The active threshold adjustment circuits 801, 811, 901 may be configured to provide and adjust an adjustable detection threshold, Vₜ. The adjustable detection threshold may be adjustable when, or during, a time period when unwanted signals resultant from interference and/or objects closer to the detector than the object of interest are expected to occur. For example, the adjustable detection threshold can be time-adjusted in order to optimize the signal-to-noise ratio (SNR) at different ranges during the flight time of the light packet. Cancellation of the nearby interference may utilize a higher threshold for the duration of time in which the light packet is “close” to the LiDAR unit when being sent or transmitted. For example, the adjustable detection threshold may be increased for an undesired signal time period following the transmission of a light packet. The undesired signal time period may be between about 5 nanoseconds and 50 nanoseconds. In at least one embodiment, the undesired signal time period may be 15 nanoseconds. In at least one embodiment, the undesired signal time period may be greater than or equal to 5 nanoseconds, greater than or equal to 10 nanoseconds, greater than or equal to 15 nanoseconds, greater than or equal to 20 nanoseconds, greater than or equal to 25 nanoseconds, etc. and/or less than or equal to 50 nanoseconds, less than or equal to 40 nanoseconds, less than or equal to 30 nanoseconds, less than or equal to 27 nanoseconds, less than or equal to 23 nanoseconds, less than or equal to 17 nanoseconds, etc. Further, for example, it may be described that the adjustable detection threshold may be adjusted according to a stepped threshold or ramp function of the adjustable detection threshold over the determined distance. More specifically, for example, a LiDAR range equation (e.g., 1/r 2) may be utilized to determine adjustable detection threshold based on the determined distance of the object of interest. An illustrative function of Vi over time is depicted in FIG. 11. The long-dashed line is representative of a nominal detection threshold 1102 used to detect a reflection of an object of interest over a sensing time period or window 1112. The solid line is representative of an adjustable detection threshold 1104 used to detect a reflection of an object of interest over a sensing time period or window 1112 to reduce undesired signals within the reflected signal using the circuits of FIGS. 8-9. As shown, the adjustable detection threshold 1104 is adjusted to an increased value for the undesired signal time period 1110 following the transmission of a light pulse and then is adjusted to back to the nominal detection threshold 1102 after the expiration of the undesired signal time period. Additionally, as shown, the adjustable detection threshold 1104 may be decreased immediately following the expiration of the undesired signal time period 1110 as shown by the short-dashed line or in a gradual fashion as shown by the solid line. In other words, the adjustable detection threshold may be increased before and during the laser pulse, and once interference potential has cleared (e.g., light is beyond the front glass of the LiDAR system), then the adjustable detection threshold can be lowered, either instantly or gradually.

It is to be understood that the LiDAR system 100 described herein is capable of and configured to scan a plurality of different directions across two axes resulting in an array of data points for each scan cycle of the system 100. When describing the embodiments depicted in FIGS. 8-9, it is to be understood that the Vₜ may be adjusted for a single unique scan direction, a group of proximate scan directions, etc., based, for example, on the determined distance to the object of interest determined from the previous scan cycle. For example, with respect to a single particular scan direction or pixel, an object of interest may be determined to be at a determined distance in a first scan cycle. Thus, the adjustable detection threshold, Vₜ, may be adjusted for the particular scan direction based on the determined distance for a second scan cycle following the first scan cycle. Additionally, adjustable detection threshold, Vₜ, may be adjusted for one or more scan directions that are proximate the particular scan direction (e.g., next to, with n directions proximate to, within a selected radius of the particular scan direction scan direction, etc.).

The active threshold adjustment circuit 801 of FIG. 8A includes a Vₜ generator 802 that is configured to determine the adjustable detection threshold, Vₜ, as described herein based on one or both of time and the determined distance to the object of interest. The Vₜ generator 802 may be operably coupled to the reference source 614, and the reference source 614 may be operably coupled to the reference input of the TIA 620 to generate a reference signal to transmit to the reference input based the adjustable detection threshold, Vₜ. Thus, the Vₜ generator 802 may determine, or generate, the adjustable detection threshold, Vₜ, and then feed, or provide, the adjustable detection threshold, Vₜ, to the reference source 614 to adjust the reference input provided to the TIA 620.

The active threshold adjustment circuit 811 of FIG. 8B includes a Vₜ generator 802 that is configured to determine the adjustable detection threshold, Vₜ, as described herein based on one or both of time and the determined distance to the object of interest. The Vₜ generator 802 may be operably coupled to the reference source 614, and the reference source 614 may be operably coupled to the reference input of a TIA 621. Thus, the Vi generator 802 and reference source 614 may work together to generate a reference signal based the adjustable detection threshold, Vₜ. In this embodiment, the TIA 621 may be described as being a 2-stage difference amplifier where the APD 608 is connected to a first amplifier 622. The reference source 614, which is controlled by the Vₜ generator 802, may be coupled to a second amplifier 623 that is in parallel with the first amplifier 622. In this way, a cancellation signal can be injected by the reference source 614 and the Vₜ generator 802 into the second amplifier 623 to reduce undesired signals within the reflected signal fed into the first amplifier 622. The output of both of the first and second amplifiers 622, 623 is coupled to the inputs of a third amplifier 624 (e.g., providing the “difference), the output of which is the effective output of the TIA 621. Thus, the Vₜ generator 802 may determine, or generate the adjustable detection threshold, Vₜ, and then feed, or provide, the adjustable detection threshold, Vₜ, to the reference source 614 to adjust the reference input provided to the TIA 621.

As shown in FIG. 9, the detection circuit 900 further includes a comparator 920 operably coupled to the TIA 620. More specifically, the output of the TIA 620 is provided, or transmitted, to an input of the comparator 920. As described herein, the TIA 620 converts the input current to a voltage signal, and then the comparator 920 produces an electrical-edge signal (e.g., a rising edge or a falling edge) when the received voltage signal from the TIA 620 rises above or falls below the adjustable detection threshold voltage Vₜ. A dashed line is shown connecting the output of the TIA 620 to the input of the comparator 920 to indicate that the output of the TIA 620 may be directly or indirectly operably coupled to the input of the comparator 920. In other words, no, one, or more than one other circuit components may be operably coupled between the TIA 620 and the comparator 920. In this embodiment, a Vi generator 902, similar to the Vₜ generator 802 of FIG. 8, may determine, or generate the adjustable detection threshold, Vₜ, based on the determined distance to the object of interest that may be provided by the time/distance determination circuit 508. Then, Vₜ generator 902, may feed, or provide, the adjustable detection threshold, Vₜ, to the comparator 920 to produce an electrical-edge signal when the received voltage signal from the TIA 620 rises above or falls below the adjustable detection threshold voltage Vₜ indicating a detected object within the signal.

Another illustrative detection circuit 1001 of the LiDAR system of FIG. 1 utilizes a switch 1002 to reduce undesired signals within the reflected signal. The switch 1002 operably positioned between the output of the TIA 620 and an input of the comparator 920 so as to be configurable to operably disconnect the output of the TIA 620 from the input of the comparator 920. The switch 1002 may be operably coupled to a switching control circuit 1004 that may be configured to determine when undesired signals are expected to be transmitted through the detection circuit 1000, and in particular, when the undesired signals are transmitted from the TIA 620 to the comparator 920. The switching control circuit 1004 may then operate the switch 1002 to disconnect (e.g., “switched off”) the output of the TIA 620 from the input of the comparator 920 to block or mask the undesired signals from the comparator 920. Conversely, the switching control circuit 1004 may also operate the switch 1002 to re-connect (e.g., “switched on”) the output of the TIA 620 from the input of the comparator 920 to allow desired signals (e.g., reflected signals indicative of objects of interest) to be received by the comparator 920.

The switch 1002 may be any circuitry configured to prevents signals from reaching the pulse discrimination circuitry and comparator 920, thereby preventing initial reflections off the glass from reaching the time/distance determination circuit 508 resulting in the time/distance determination circuit 508 being prevented from “seeing” the unwanted pulses. In one embodiment, to determine when undesired signals may be transmitted through the detection circuit 1000, the switching control circuit 1004 may be operably coupled to the time/distance determination circuit 508, which may be provide timing and/or distance information regarding the object of interest to the switching control circuit 1004. The timing and/or distance information regarding the object of interest may then be used, or utilized, by the switching control circuit 1004 to determine when desired signals (e.g., reflected signals of the object of interest) are to be expected to be received and processed through the detection circuit 1000.

In another embodiment, to determine when undesired signals may be transmitted through the detection circuit 1000, the switching control circuit 1004 may be operably coupled to the emitter circuit 200 to determine when emitted light is being transmitted, or sent, out of the LiDAR system, to the object of interest, etc. The timing of the emitted light (e.g., the time at which the light is transmitted) may be used to determine when undesired signals would likely be received by the detector circuit 100. For instance, it may be known that undesired signals (e.g., reflections or optical distortions caused by emitter circuit 200 or other apparatus of the LiDAR system 100) are received with an undesired signal time period immediately following the transmission of the emitted light. Thus, the switching control circuit 1004 may disconnect the output of the TIA 620 from the input of the comparator 920 during the undesired signal time period. The undesired signal time period may be between about 5 nanoseconds and 50 nanoseconds as described above. In at least one embodiment, the undesired signal time period may be 30 nanoseconds.

Below there is provided a non-exhaustive listing of non-limiting examples. Any one or more of the features of these examples may be combined with any one or more features of another example, embodiment, or aspect described herein.

Example Ex1: An apparatus comprising:
an amplifier to receive a reflected signal representative of a light signal received by an optical detector in a light detection and ranging (LiDAR) system;
and a current injection circuit operably coupled to the optical detector and configured to inject an interference reduction current into the optical detector to reduce undesired signals within the reflected signal.

Example Ex2: A method for light detection and ranging (LiDAR) comprising:
providing a reflected signal representative of a light signal received by an optical detector in a LiDAR system to an amplifier; and
injecting an interference reduction current into the optical detector using a current injection circuit to reduce undesired signals within the reflected signal.

Example Ex3: The apparatus as in Example Ex1 or the method as in Example Ex2, wherein the current injection circuit is operably coupled to a cathode of the optical detector to inject the interference reduction current into the cathode of the optical detector, wherein the anode of the optical detector is operably coupled to the amplifier to transmit the reflected signal adjusted by the interference reduction current.

Example Ex4: The apparatus or method as in any one of Examples Ex1-Ex3, wherein the current injection circuit comprises an AC coupled voltage waveform source to provide the interference reduction current.

Example Ex5: The apparatus or method as in Example Ex4, wherein the AC coupled voltage waveform source comprises an AC voltage waveform source and a capacitor operably coupled between the AC voltage waveform source and the optical detector to reduce a DC component from the interference reduction current.

Example Ex6: The apparatus or method as in any one of Examples Ex1-Ex5, wherein the current injection circuit is operably coupled to an anode of the optical detector to inject the interference reduction current into the anode of the optical detector, wherein the anode of the optical detector is operably coupled to the amplifier to transmit the reflected signal adjusted by the interference reduction current.

Example Ex7: The apparatus or method as in any one of Examples Ex1-Ex6, wherein the interference reduction current is less than or equal to about 20 microamperes.

Example Ex8: An apparatus comprising:
an amplifier to receive a reflected signal representative of a light signal received by an optical detector in a light detection and ranging (LiDAR) system; and
an active threshold adjustment circuit operably coupled to the amplifier and configured to:
   provide an adjustable detection threshold used to detect an object of interest; and
   increase the adjustable detection threshold to reduce undesired signals within the reflected signal.

Example Ex9: The apparatus as in Example Ex8, wherein the apparatus further comprises a comparator operably coupled to the amplifier to receive an output of the amplifier and operably coupled to active threshold adjustment circuit to receive the adjustable detection threshold, wherein the comparator generates an edge signal indicative of the object of interest in response to the received output being greater than or equal to the adjustable detection threshold.

Example Ex10: A method for light detection and ranging (LiDAR) comprising:
providing a reflected signal representative of a light signal received by an optical detector in a LiDAR system to an amplifier;
providing, using an active threshold adjustment circuit operably coupled to the amplifier, an adjustable detection threshold used to detect an object of interest; and
increasing the adjustable detection threshold to reduce undesired signals within the reflected signal.

Example Ex11: The method as in Example Ex10, wherein the method further comprises generating an edge signal indicative of the object of interest, using a comparator, in response to a received output being greater than or equal to the adjustable detection threshold, wherein the comparator is operably coupled to the amplifier to receive an output of the amplifier and operably coupled to active threshold adjustment circuit to receive the adjustable detection threshold.

Example Ex12: The apparatus or method as in any one of Examples Ex8-Ex11, wherein the active threshold adjustment circuit comprises a voltage source operably coupled to a reference input of the amplifier and configured to generate a reference signal to transmit to the reference input based the adjustable detection threshold.

Example Ex13: The apparatus or method as in any one of Examples Ex8-Ex12, wherein increasing the adjustable detection threshold comprises increasing the adjustable detection threshold according to a stepped threshold or ramp function.

Example Ex14: An apparatus comprising:
an amplifier to receive a reflected signal representative of a light signal received by an optical detector in a light detection and ranging (LiDAR) system;
a comparator operably coupled to the amplifier to receive an output of the amplifier and to generates an edge signal indicative of an object of interest in response to the received output; and
a switch operably positioned between the output of the amplifier and the comparator to operably disconnect the output of the amplifier from the comparator when undesired signals are expected to be received by the comparator from the amplifier.

Example Ex15: A method for light detection and ranging (LiDAR) comprising:
providing a reflected signal representative of a light signal received by an optical detector in a LiDAR system to an amplifier;
generating an edge signal indicative of an object of interest, using a comparator, in response to received output, wherein the comparator is operably coupled to the amplifier to receive an output of the amplifier; and
operably disconnecting the output of the amplifier from the comparator when undesired signals are expected to be received by the comparator from the amplifier.

Example Ex16: The apparatus or method as in any one of Examples Ex1-Ex15, wherein the optical detector comprises an avalanche photodiode.

Example Ex17: The apparatus or method as in any one of Examples Ex1-Ex16, wherein the amplifier is a transimpedance amplifier (TIA) that converts current pulses obtained from a photodetector to voltage pulses to be utilized to determine the distance to the object of interest.

Alternative implementations disclosed herein provide an apparatus including an amplifier to receive a reflected signal representative of a light signal received by an optical detector in a light detection and ranging (LiDAR) system, and an active threshold adjustment circuit operably coupled to the amplifier and configured to provide an adjustable detection threshold used to detect an object of interest and increase the adjustable detection threshold to reduce undesired signals within the reflected signal, wherein the amplifier is a transimpedance amplifier (TIA) that converts current pulses obtained from a photodetector to voltage pulses to be utilized to determine the distance to the object of interest.

In an alternative implementation, a method for light detection and ranging (LiDAR) as disclosed herein includes providing a reflected signal representative of a light signal received by an optical detector in a LiDAR system to an amplifier, providing, using an active threshold adjustment circuit operably coupled to the amplifier, an adjustable detection threshold used to detect an object of interest, and increasing the adjustable detection threshold to reduce undesired signals within the reflected signal.

In one implementation, the method further includes generating an edge signal indicative of the object of interest, using a comparator, in response to a received output being greater than or equal to the adjustable detection threshold, wherein the comparator is operably coupled to the amplifier to receive an output of the amplifier and operably coupled to active threshold adjustment circuit to receive the adjustable detection threshold.

In one implementation, the active threshold adjustment circuit comprises a voltage source operably coupled to a reference input of the amplifier and configured to generate a reference signal to transmit to the reference input based on the adjustable detection threshold.

In one implementation, increasing the adjustable detection threshold comprises increasing the adjustable detection threshold according to a stepped threshold or ramp function. In one implementation, the amplifier is a transimpedance amplifier (TIA) that converts current pulses obtained from a photodetector to voltage pulses to be utilized to determine the distance to the object of interest.

An apparatus disclosed herein includes an amplifier to receive a reflected signal representative of a light signal received by an optical detector in a light detection and ranging (LiDAR) system, a comparator operably coupled to the amplifier to receive an output of the amplifier and to generate an edge signal indicative of an object of interest in response to the received output, and a switch operably positioned between the output of the amplifier and the comparator to operably disconnect the output of the amplifier from the comparator when undesired signals are expected to be received by the comparator from the amplifier. In one implementation, the amplifier is a transimpedance amplifier (TIA) that converts current pulses obtained from a photodetector to voltage pulses to be utilized to determine the distance to the object of interest. In one implementation, the optical detector comprises an avalanche photodiode.

A method for light detection and ranging (LiDAR) disclosed herein includes providing a reflected signal representative of a light signal received by an optical detector in a LiDAR system to an amplifier, generating an edge signal indicative of an object of interest, using a comparator, in response to received output, wherein the comparator is operably coupled to the amplifier to receive an output of the amplifier, and operably disconnecting the output of the amplifier from the comparator when undesired signals are expected to be received by the comparator from the amplifier. In one implementation, the optical detector comprises an avalanche photodiode. In one implementation, the amplifier is a transimpedance amplifier (TIA) that converts current pulses obtained from a photodetector to voltage pulses to be utilized to determine the distance to the object of interest.

In the preceding description, reference is made to the accompanying set of drawings that form a part hereof and in which are shown by way of illustration several specific embodiments. It is to be understood that other embodiments are contemplated and may be made without departing from (e.g., still falling within) the scope or spirit of the present disclosure. The preceding detailed description, therefore, is not to be taken in a limiting sense. The definitions provided herein are to facilitate understanding of certain terms used frequently herein and are not meant to limit the scope of the present disclosure.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise. As used herein, “or” is generally employed in its sense including “and/or” unless the content clearly dictates otherwise. As used herein, “have,” “having,” “include,” “including,” “comprise,” “comprising,” or the like are used in their open-ended sense, and generally mean “including, but not limited to.”

Embodiments of LiDAR apparatus and methods performed thereby are disclosed. The implementations described above and other implementations are within the scope of the following claims. One skilled in the art will appreciate that the present disclosure can be practiced with embodiments other than those disclosed. The disclosed embodiments are presented for purposes of illustration and not limitation, and the present disclosure is limited only by the claims that follow.

What is claimed:

1. An apparatus comprising:
an amplifier to receive a reflected signal representative of a light signal received by an optical detector in a light detection and ranging (LiDAR) system; and
a current injection circuit operably coupled to the optical detector and configured to inject an interference reduction current into the optical detector to reduce undesired signals within the reflected signal.

2. The apparatus of claim 1, wherein the current injection circuit is operably coupled to a cathode of the optical detector to inject the interference reduction current into the cathode of the optical detector, wherein the anode of the optical detector is operably coupled to the amplifier to transmit the reflected signal adjusted by the interference reduction current.

3. The apparatus of claim 1, wherein the current injection circuit comprises an AC coupled voltage waveform source to provide the interference reduction current.

4. The apparatus of claim 3, wherein the AC coupled voltage waveform source comprises an AC voltage waveform source and a capacitor operably coupled between the AC voltage waveform source and the optical detector to reduce a DC component from the interference reduction current.

5. The apparatus of claim 1, wherein the current injection circuit is operably coupled to an anode of the optical detector to inject the interference reduction current into the anode of the optical detector, wherein the anode of the optical detector is operably coupled to the amplifier to transmit the reflected signal adjusted by the interference reduction current.

6. The apparatus of claim 1, wherein the interference reduction current is less than or equal to about 20 microamperes.

7. The apparatus of claim 1, wherein the optical detector comprises an avalanche photodiode.

8. The apparatus of claim 1, wherein the amplifier is a transimpedance amplifier (TIA) that converts current pulses obtained from a photodetector to voltage pulses to be utilized to determine the distance to the object of interest.

9. A method for light detection and ranging (LiDAR) comprising:
providing a reflected signal representative of a light signal received by an optical detector in a LiDAR system to an amplifier; and
injecting an interference reduction current into the optical detector using a current injection circuit to reduce undesired signals within the reflected signal.

10. The method of claim 9, wherein the current injection circuit is operably coupled to a cathode of the optical detector to inject the interference reduction current into the cathode of the optical detector, wherein the anode of the optical detector is operably coupled to the amplifier to transmit the reflected signal adjusted by the interference reduction current.

11. The method of claim 9, wherein the current injection circuit comprises an AC coupled voltage waveform source to provide the interference reduction current.

12. The method of claim 11, wherein the AC coupled voltage waveform source comprises an AC voltage waveform source and a capacitor operably coupled between the AC voltage waveform source and the optical detector to reduce a DC component from the interference reduction current.

13. The method of claim 9, wherein the current injection circuit is operably coupled to an anode of the optical detector to inject the interference reduction current into the anode of the optical detector, wherein the anode of the optical detector is operably coupled to the amplifier to transmit the reflected signal adjusted by the interference reduction current.

14. The method of claim 9, wherein the interference reduction current is less than or equal to about 20 microamperes.

15. The method of claim 9, wherein the optical detector comprises an avalanche photodiode.

16. The method of claim 9, wherein the amplifier is a transimpedance amplifier (TIA) that converts current pulses obtained from a photodetector to voltage pulses to be utilized to determine the distance to the object of interest.

17. An apparatus comprising:
an amplifier to receive a reflected signal representative of a light signal received by an optical detector in a light detection and ranging (LiDAR) system; and
an active threshold adjustment circuit operably coupled to the amplifier and configured to:
provide an adjustable detection threshold used to detect an object of interest; and
increase the adjustable detection threshold to reduce undesired signals within the reflected signal.

18. The apparatus of claim 17, wherein the apparatus further comprises a comparator operably coupled to the amplifier to receive an output of the amplifier and operably coupled to active threshold adjustment circuit to receive the adjustable detection threshold, wherein the comparator generates an edge signal indicative of the object of interest in response to the received output being greater than or equal to the adjustable detection threshold.

19. The apparatus of claim 17, wherein the active threshold adjustment circuit comprises a voltage source operably coupled to a reference input of the amplifier and configured to generate a reference signal to transmit to the reference input based the adjustable detection threshold.

20. The apparatus of claim 17, wherein increasing the adjustable detection threshold comprises increasing the adjustable detection threshold according to a stepped threshold or ramp function.
